(19) United States
(12) Patent Application Publication
(10) Pub. No.: US 2021/0246402 A1
(43) Pub. Date: Aug. 12, 2021

(54) METHOD AND EQUIPMENT FOR THE PREPARATION OF A FOOD PRODUCT, IN PARTICULAR BERRY BASED

(71) Applicant: PERA-PELLENC SA, Florensac (FR)

(72) Inventor: Jean-Luc FAVAREL, Florensac (FR)

(21) Appl. No.: 17/171,735

(22) Filed: Feb. 9, 2021

(30) Foreign Application Priority Data
Feb. 11, 2020 (FR) 2001328

(51) Int. Cl. C12G 1/022; C12G 1/028; C12G 1/00

(52) U.S. Cl. CPC C12G 1/0203; C12G 1/005; C12G 1/0213

(57) ABSTRACT

A method and equipment for preparation of a berry-based food product, and in particular a grape-based product, which includes the following successive steps: (a) enzymatic maceration of the berries; (b) pressing of the berries, with the separation of juice from the berries and from solid particles from the berries; (c) treating the juice from the berries by decompression, where the treatment comprises elimination of condensates formed during the decompression. Flash-decompression equipment which could be used to practice the method is also disclosed. The method and equipment also has applications in the treatment of juice from berries and in particular to the production of wine.

### BACKGROUND OF THE INVENTION

### 1. Field of the Invention

The present invention relates to a method and equipment for preparation of a fruit-based food product, notably berry-based, and in particular based on grapes.

The method from the invention can be profitably used in particular in the winemaking process. It aims not only to improve the extraction of the aromatic precursors from the berries but also to avoid certain compounds which could harm the gustatory quality of the food product, and the wine coming from it.

The invention is applicable to the agri-food field and in particular to the preparation of wine, but also to fermented products coming from fruit juice, for example from the juice from apples, pears, cherries, blueberries, etc.

### 2. Description of Related Art Including Information Disclosed Under 37 CFR 1.97 and 37 CFR 1.98

The berry, and in particular the grape, is made up of pulp and a skin, the covering surrounding the pulp. The pulp essentially contains juice, rich in sugars, acids and water. The juice is released by crushing the berry. This can take place during crushing, during pressing of the harvest, but also during a mechanical harvest, during pumping or a transfer which the grape undergoes.

The skin contains numerous aromatic precursors, tannins, anthocyanins, polysaccharides and also other molecules involved in the quality of the wine. The tannins contribute to the development of the flavor of the wine, the anthocyanins contribute to the color of the wine, the polysaccharides contribute to the unctuousness and the fullness of the wine in the mouth, whereas the flavor precursors contribute to the taste and the nose of the wine. Several techniques are available to the winemaker for extracting and assaying these compounds.

The following known techniques can in particular be brought up:
rack and return: It consists of emptying a vat containing grapes, juice therefrom and re-adding the juice above a brown cap formed in the tank so as to extract the compounds retained in the brown cap;
pumping over: Comparable to rack and return, it consists of pumping the juice accumulated in the lower part of the vat containing the juice and re-adding it in an upper part of the vat;
using extraction enzymes: The enzymes are used to cause a lysis, meaning a breaking up of the vegetable cells of the berries, in order to release the content thereof;
heat treatment: It involves an extraction with heat essentially releasing the anthocyanins contained in the skin of the berries;
decompression: This method, also called “flash decompression,” “détente” or decompression under vacuum, consists of quickly lowering the pressure of the atmosphere surrounding the berries so as to create a vacuum. The decompression causes the vaporization of the intracellular water in the skins, the opening of the cells and the release of tannins, anthocyanins, polysaccharides and aroma precursors.

A description of the decompression and enzyme treatment technique can be found, for example, in the patent FR2980800.

### BRIEF SUMMARY OF THE INVENTION

The invention follows from the observation of some number of negative effects affecting the wine and which could result from the extraction or from subsequent wine making and maturing operations.

The first difficulty, related to a high extraction, for example an extraction by decompression, is the potentially excessive presence of astringent tannins or herbaceous compounds, negatively influencing the olfactory and gustatory perception of the wine.

Another difficulty, also leading to a deterioration of the organoleptic qualities of the wine, is seen during treatment of grapes affected by “smoke taint,” meaning vines which were exposed to smoke.

This phenomenon happens when smoke from a fire, for example a seasonal brushfire or forest fire, reaches a vineyard. In particular it affects winegrowing regions in California, Australia and Portugal. The smoke settling on the vine tends to generate volatile phenolic compounds in the vegetation, in particular compounds from the ethylphenol family. These could be accumulated in the berries, in particular at the time of the onset of ripening of the vine, and could be released during making or maturing of the wine.

The goal of the invention is thus to propose a method for preparation of a berry-based food product, and in particular a grape berry-based food product, with which to overcome the aforementioned difficulties, by supporting, as applicable, subsequent wine making and maturing operations for a faultless wine. The reference to grape berries in the following description is understood as not excluding implementing the invention with other types of berries or fruits. The invention can in fact be put into practice for treating berries or drupes such as for example blackcurrant berries or cranberries, but also cherries, pears or apples.

Another goal is to propose such a method which is compatible with various extraction processes, including those leading to a high extraction of the compounds from the skin of the berries.

Another goal is to propose equipment with which to implement the method.

To achieve these goals, the invention proposes a method for preparation of a berry-based food product, and in particular a grape-based product, and comprises the following successive steps:

a) enzymatic maceration of the berries;

b) pressing of the berries, with the separation of juice from the berries and from solid particles from the berries;

c) treating the juice from the berries by decompression, where the treatment comprises elimination of condensates formed during the decompression.

Here, enzymatic maceration of the berries is understood to mean a treatment step during which solid particles including skins of the berries, seeds and possibly stalk residues are in contact with the juice. In the context of winemaking, this operation may for example be preceded by crushing. Maceration is called enzymatic in so far as endogenic or exogenic enzymes are used for cutting the peptide chains in the skins and releasing the compounds contained in the berry's skins. In connection with winemaking, enzymatic maceration improves the release of tannins, anthocyanins, polysaccharides and aromatic precursors in particular.

As indicated above, the enzymes may be endogenic enzymes, naturally present on the berries, and/or exogenic enzymes, meaning added enzymes. In particular, step a) of the method, meaning maceration, may comprise a seeding of the berries with at least one pectolytic enzyme. The added enzyme(s) can be chosen, for example, from polygalacturonase, rhamnogalacturonase, a pectin esterase or a pectin lyase.

Possibly, the heating operation occurring before step a) of the method may be used for denaturing endogenic enzymes present on the grape berries. This serves as needed to eliminate the laccases coming from gray rot, or polyphenol oxidases which could cause undesired oxidation. Heating also serves to neutralize possible contaminants and in particular endogenic yeasts which could induce organoleptic deviations. For example, brettanomyces type yeasts can be neutralized.

Maceration from step a) may preferably be done at a temperature over 55° C. and under 60° C. The temperature may be adjusted by heating or cooling.

A temperature over 50° C., and preferably over 55° C., contributes to avoiding or limiting alcoholic fermentation during the maceration step. This temperature is in particular too high for the multiplication of fermentation yeasts such as Saccharomyces cervesiae. Alcohol molecules which could be formed during maceration in fact risk being denatured or eliminated by the subsequent decompression (flash-decompression) done during step c). In particular, ethanol molecules produced by alcoholic fermentation would be eliminated concurrently with the water, even preferentially over the water, during elimination of decompression condensates in step c) of the method.

Implementation of a slow maceration at temperatures below 55° C. is not however excluded.

Further, maceration may preferably be done at a temperature below 60° C. While enhancing maceration, a temperature below 60° C. serves to avoid an alteration of the maceration enzymes.

The temperature range and in particular the temperature over 55° C. can be held during the pressing and separation of the juice, or must, and until the treatment of the berries by decompression.

Preferably, the pressing and separation of the juice from the berries and particles may also be done at a temperature over 50° C. in order to avoid or limit a possible alcoholic fermentation. The pressing and separation of the juice from the particles may be done, in a press, for example a membrane winemaking press. Separation by centrifuging is also conceivable.

Step c) of the method comprises a decompression also called “flash decompression” or “flash détente.” This operation can be done by abruptly lowering the pressure of an enclosure containing the berry juice. However, and preferably, the decompression operation can also be done continuously by passing the berry juice through a flash decompression reaction vessel with a reduced pressure (also called “vacuum”) relative to atmospheric pressure. Such equipment is known as such and sold, for example, by Pera-Pellenc S.A.

The decompression has the double effect of lowering the temperature of the juice but also causing evaporation of some components of the juice, and in particular the water that it contains. The evaporated components, and in particular the evaporated water, are condensed and the condensates are eliminated.

Evaporation of the water and elimination of the condensate serves not only to obtain a more concentrated juice, and stronger color, but also serves to eliminate some harmful compounds such as herbaceous compounds and pyrazines which could have been released during the steps of maceration and pressing before the decompression. In particular, it is possible to eliminate compounds from the ethylphenol family that accumulated in the berries and came from the “smoke-tainted” phenomenon previously discussed. It should be emphasized that, advantageously, decompression treatment serves to eliminate volatile herbaceous compounds released during enzymatic maceration and pressing without also causing a new extraction of tannin.

The juice resulting at the end of the method, and in particular the juice obtained from grape berries, thus has improved properties for wine making and maturing.

Also, the method may further comprise a step of alcoholic fermentation of the berry juice, at the end of step c).

The decompression treatment in step c) can be modulated in intensity so as to adjust the elimination of water and certain compounds from the juice and limit it, for example, to 8 to 10% of the volume of juice treated. The parameters for modulation of the intensity of the decompression treatment are the initial temperature of the juice and the size of the reduced pressure. The high initial temperature and a large pressure reduction have the effect of increasing the intensity of the decompression, whereas a lower initial temperature and a smaller pressure reduction have the effect of moderating it.

In the context of the method from the invention, the initial temperature of the berry juice just before decompression is preferably included between 75° C. and 85° C. while the pressure reduction is done with an absolute residual pressure preferably included between 40 and 60 mbar (4000 to 6000 Pa).

To get an ideal temperature for the pressure reduction treatment, step c) of treatment of the berry juice by decompression may be preceded by heating the berry juice to a temperature included between 75° C. and 85° C.

The decompression treatment has the effect of lowering the temperature of the juice, which supports the alcoholic fermentation thereof which could be done at the end of the decompression. As needed, the juice may undergo an additional cooling or more generally an adjustment of the temperature thereof to the needs of fermentation. This temperature is for example from 30° C. to 35° C.

The invention can be implemented simply for optimizing a hot pre-fermentation maceration and for getting a juice with improved properties.

The invention may also be implemented, in particular for winemaking applications thereof, in the context of a more complete treatment starting with harvested berries.

In particular, the method may further comprise, prior to step a), a treatment of the berries by decompression in a decompression chamber. This first decompression, also flash decompression type, takes place before enzymatic maceration and before a second decompression, which is the decompression previously described and done in step c) of the method.

For simplification, in the remainder of the description, the decompression done on the berries, meaning the decompression done before step a) of the method, is designated by “first decompression” whereas the decompression done on the berry juice, during step c) of the method, is designated by “second decompression.”

The first decompression mayor may not be accompanied by the elimination, of the condensates resulting from the decompression. Just the same, and preferably, the method may comprise an elimination of condensates formed during the treatment of the berries by the first decompression. The elimination of the condensate serves to eliminate in particular some free undesirable molecules (not bound to sugars) such as, for example, molecules resulting from exposure of the berries to smoke (“smoke taint”).

The first decompression also serves to cause a bursting of cells of the berries and thus to enhance the enzymatic activity during the subsequent maceration during step a) of the method.

In an application to the production of wine, it is possible to get wines that are softer and richer in oligosaccharides characterized by a full viscous mouth feel.

The first decompression is preferably less intense than the second decompression.

It can preferably be done starting from an initial temperature of the berries of 75° C. to 85° C. and an absolute residual pressure (or a “vacuum”) of 200 to 300 mbar (20,000 to 30,000 Pa).

Also, the treatment of the berries can be preceded by heating the berries to the aforementioned initial temperature included between 75° C. and 85° C.

The decompression operating on the grape berries has the effect of lowering the temperature thereof. Ideally, the decompression can be driven, by adjusting, for example, the initial temperature and or the pressure reduction such that the final temperature of the berries is in a range included between 55° C. and 60° C. In that way, by means of the first pressure reduction, the berries can be directly brought to an ideal temperature for starting the enzymatic maceration for step a) of the method. This may then take place directly at the outlet of the flash decompression reaction vessel.

Otherwise, the berries may be cooled or reheated.

The treatment of berries by decompression, meaning the first decompression, and the treatment of the berry juice by decompression during step c), meaning the second decompression, can take place in separate flash decompression reaction vessels. These two decompressions can also take place in a single decompression chamber, meaning by successive passage of the berries and the juice in a single decompression chamber.

The invention also relates to decompression equipment, and in particular to a decompression reaction vessel, for the preparation of a food product according to the method described above, and in particular for the method involving the first and second decompression.

The equipment comprises:
a decompression chamber;
at least one supply pump, for supplying the decompression chamber;
at least one extraction pump, for emptying the decompression chamber;
at least one filling probe for the decompression chamber;
a control device for the supply pump and the extraction pump, where the control device receives a signal from said filling probe and is sensitive to a low filling level of the decompression chamber, an intermediate filling level of the decompression chamber and at least one high filling level of the decompression chamber.

The control device is configured for causing:
stopping, respectively reducing the flow rate, of the extraction pump when content in the decompression chamber reaches the low filling level;
running, respectively increasing the flow rate, of the extraction pump when content in the decompression chamber reaches the intermediate filling level;
stopping, respectively reducing the flow rate, of the supply pump when content in the decompression chamber reaches a high filling level of the vat.

Conforming to the invention, the equipment further comprises a command for switching between:
a first mode of operation, corresponding to the treatment of the berries by decompression, wherein the control device is sensitive to a first high level, and wherein the supply pump is stopped, respectively the flow rate thereof is reduced, when the content of the decompression chamber reaches the first high filling level; and
a second mode of operation, corresponding to the treatment of the juice from the berries by decompression, wherein the control device is sensitive to at least one second high level, above the first high level, and wherein the supply pump is stopped, respectively the flow rate thereof is reduced, when the content of the decompression chamber reaches the second high filling level.

The first and second mode of operation are implemented respectively for the “first decompression” and the “second decompression.”

The supply pump and the extraction pump serve respectively to supply the decompression chamber with berries or juice to be processed, and to extract the processed berries or juice from the decompression chamber.

The change of the “high-level” and in particular the distinction of at least two high levels selectively implemented for the treatment of berries and the treatment of juice allows an optimal operation of the equipment and serves to avoid phenomena of obstruction and cavitation upstream from the extraction pump.

This results in an improved operation of the decompression chamber and especially the possibility of using the same equipment for both decompression operations.

Advantageously the equipment may comprise a plurality of filling probes, where at least one filling probe is respectively associated with the low filling level, intermediate filling level, first high filling level, and second high filling level.

As an example, four probes can thus be used respectively for the low level, intermediate level, first high level and second high level.

According to another possibility, the equipment may comprise a filling probe associated with the high filling level, where the probe has a freedom of movement in the decompression chamber between a first position corresponding to the first high filling level and second position corresponding to the second high filling level.

The equipment may in that case be configured for the first decompression by lowering the position of the associated probe to the high level and may be configured for the second decompression by raising the same probe.

The probe sensitive to the low-level and the intermediate level may be fixed.

According to still another possibility, however less easy to implement, the equipment may comprise a single probe capable of delivering a signal proportional to the filling of the decompression chamber. In this case, the signal is compared to the low level and intermediate level settings, and to the high-level settings for controlling the operation of the equipment. The vacuum pump connected to the decompression chamber is distinct from the extraction pump. The vacuum pump may be driven for various residual pressures or several vacuum levels so as to achieve a stronger or weaker decompression. Preferably, the first decompression may be weaker. It is then designated by “partial decompression.” The second decompression, when it is done with the deeper vacuum, is designated by “total decompression.”

Other characteristics and advantages of the invention will emerge from the description which follows and references the figures from the drawings. This description is given for illustration and is nonlimiting.

### BRIEF DESCRIPTION OF THE SEVERAL VIEWS OF THE DRAWINGS

FIG. 1 is a logic flowchart indicating the main operations of a method for preparation of a food product according to the invention.

FIG. 2 is a simplified schematic representation of equipment for preparation of a food product according to the invention.

The figures are schematic and are made at an arbitrary scale.

### DETAILED DESCRIPTION OF THE INVENTION

In the following descriptions, identical or equivalent parts from different figures have the same references.

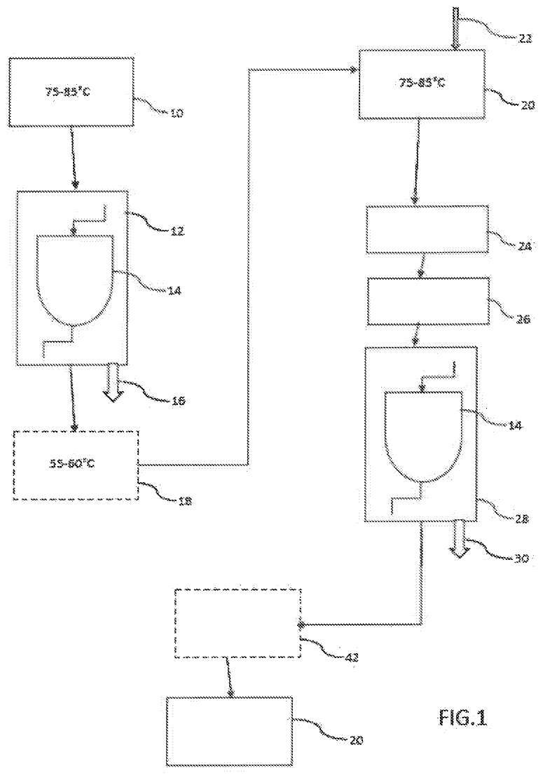

The logic flowchart from FIG. 1 shows on the left-hand side the steps which could be implemented on the berries processed by the method from the invention.

It involves a first heating 10 of berries to an initial temperature included for example between 75° C. and 85° C. When the berries have reached the initial temperature, they undergo a decompression treatment 12 (flash decompression) performed in a decompression chamber 14 indicated symbolically.

The decompression of the berries may be accompanied by an elimination of the condensates formed during the decompression. The elimination of the condensate is symbolized by the arrow 16.

At the end of this first decompression, done on the berries, the temperature of the berries may be adjusted, if necessary, during reheating, or cooling, step 18 such that the berries are at a temperature preferably included between 55° C. and 60° C.

The main phase of the method, shown on the right part of the logic flowchart from FIG. 1 can then start. It comprises an enzymatic maceration of the berries 20. During the maceration, exogenous enzymes may be added to the berries. The addition of exogenous enzymes is symbolized by an arrow 22. The maceration takes place by preferably holding the temperature in the aforementioned temperature range from 55° C. to 60° C. The length of the maceration can be from a few hours to 1 or 2 days.

The maceration of the berries is followed by their pressing, accompanied by the separation of berry juice and solid particles. The pressing and collection of the berry juice are indicated with reference 24. In the case of a treatment of grape berries, the juice, or the must, on the one hand is thus separated from the pulp and possible stalks on the other hand. The pulp and stalks are eliminated and may be reused separately.

The juice resulting from the pressing may then be heated during a heating step 26. The juice is heated to a temperature preferably included between 75° C. and 85° C. This temperature range is identical to that reached during the heating operation 18 previously indicated.

The heated juice is poured into a decompression chamber and undergoes a decompression 28 (flash decompression). The decompression may be done in a different decompression chamber from that used for step 12 or in the same decompression chamber 14. The decompression is accompanied by an elimination of condensates 30, symbolized by an arrow.

The juice, coming from the decompression 28, may be stored, or may be used immediately for continuing treatment thereof. In particular, when the berries are grape berries, the juice may be used in a winemaking method comprising an alcoholic fermentation step 40. The fermentation may be preceded by an adjustment of the temperature of the juice 42 during which the temperature of the juice is held in a range from 20° C. to 30° C. According to the parameters of the decompression 28, the temperature of the juice at the outlet of the decompression chamber may be adjusted for being directly in the desired range.

The adjustment of the temperature and control thereof may be continued during alcoholic fermentation.

Following the alcoholic fermentation, the juice, as applicable the juice from grapes, may undergo other winemaking operations, which are not described here and which are not part of the invention.

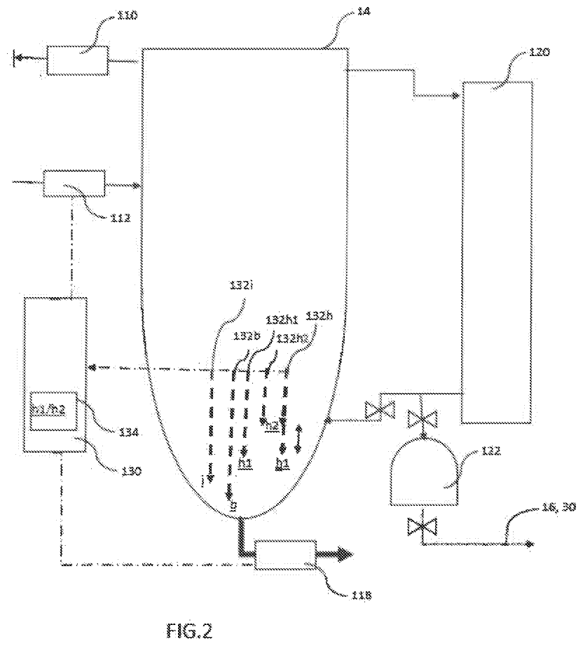

FIG. 2 shows decompression equipment which can be used for implementing the invention.

The equipment essentially comprises a decompression chamber 14 also designated by decompression reaction vessel. It involves a continuous reaction vessel into which juice or berries needing to undergo decompression can be added continuously, and from which juice or berries having undergone decompression can be extracted. The decompression chamber has a generally cylindrical shape with a conic frustum lower part for collection and extraction of the juice or berries treated by decompression.

The decompression is done by the presence in the decompression chamber of a relative vacuum. The vacuum is established and maintained by means of a vacuum pump 110.

The juice or the berries to be processed are added to the decompression chamber 14 by means of a supply pump 112. The juice or the berries processed are extracted from the lower part of the decompression chamber 14 by means of an extraction pump 118.

The decompression of the berries or the juice has the effect of causing an evaporation of water and an evaporation of some number of compounds previously described, some of which are not desired. Also, the decompression chamber is associated with a condenser 120 which receives the vapors formed and collected in the upper part of the decompression chamber.

The movement of the vapors through the condenser 120 has the effect of producing condensates which can be eliminated by an extraction balloon for the condensates 122.

A set of valves, not referenced, allows the choice of directing the condensates from the condenser 120 towards the extraction balloon for the condensates 122, or possibly to re-add all or part into the reaction vessel. The valves serve to meter the elimination of the condensates. The elimination of the condensates is symbolized by an arrow 16, 30.

The operation of the decompression is mainly governed by a control device 130. The control device 130 governs the operation of the supply pump 112 and the extraction pump 118.

In particular the control device 130 can control stopping or running the supply pump, in the case of an all or nothing type control. It may also control a reduction or an increase of the flow rate of the pumps in the case of a progressive control.

In the example shown by FIG. 2, the control device is connected to a plurality of level probes 132b, 132i, 132h1, 132h2 sensitive to the filling of the decompression chamber. Each probe is sensitive to a specific level reached by the berries or juice in a decompression chamber. A probe 132b is sensitive at a low-level b, a probe 132i is sensitive to an intermediate level i, a probe 132h1 is sensitive to a first high-level h1, and a probe 132h2 is sensitive to a second high-level h2 above the first high level. The control device receives the signal from the various probes so as to stop filling the chamber when the high level is reached, to run the extraction when the intermediate level is reached and to stop the extraction when the low level is reached. Stopping or running is understood to mean, as indicated above, as instantaneous or progressive commands.

The control device 130 may be provided with an interface 134 allowing a user to adapt the equipment either to treatment of berries, meaning for the first decompression described previously, or for a treatment of juice, meaning for a second decompression previously described.

In the case of treatment of berries, a signal from the probe 132h1 sensitive to the first high-level h1 is used for controlling stopping the supply pump. This serves to limit the maximum level of berries in the decompression chamber and avoid the formation of a cap disturbing the extraction of berries processed.

On the other hand, in the case of treatment of juice, a signal from the probe 132h2 sensitive to the second high-level h2 is used for controlling stopping the supply pump. In the case of a decompression of juice, it is in fact possible to tolerate a higher filling level and allow getting a greater decompression yield without untimely risk of obstruction.

I claim:

1. A method for preparation of a berry-based food product, and in particular a grape-based product, and comprises the following successive steps:
enzymatic maceration of the berries;
pressing of the berries, with the separation of juice from the berries and from solid particles from the berries;
treating the juice from the berries by decompression, where the treatment comprises elimination of condensates formed during the decompression.

2. The method according to claim 1, wherein the enzymatic maceration of the berries is done at a maceration temperature included between 55° C. and 60° C.

3. The method according to claim 1, wherein the pressing and the separation of the juice from solid particles from the berries is done at a temperature over 50° C.

4. The method according to claim 1, wherein the step of treatment of the berry juice by decompression is preceded by heating of the berry juice to a temperature included between 75° C. and 85° C.

5. The method according to claim 1, further comprising a step of alcoholic fermentation of the berry juice, at the end of the step of treating the juice from the berries by decompression.

6. The method according to claim 1, wherein the step of maceration comprises a seeding of the berries with one or more enzymes chosen from polygalacturonase, rhamnogalacturonase, a pectin esterase or a pectin lyase.

7. The method according to claim 1, further comprising, prior to the step of maceration, the treatment of the berries by decompression.

8. The method according to claim 7, wherein said treatment of the berries by decompression is preceded by heating of the berries to an initial temperature included between 75° C. and 85° C.

9. The method according to claim 7, comprising an elimination of condensates formed during the treatment of the berries by decompression.

10. The method according to claim 7, wherein the treatment of berries by decompression and the treatment of berry juice by decompression are done in a single decompression chamber.

11. Decompression equipment for the preparation of food products conforming to claim 8, comprising:
a decompression chamber with a condenser;
at least one supply pump for supplying the decompression chamber;
at least one extraction pump for emptying the decompression chamber;
at least one filling probe for the decompression chamber;
a control device for the supply pump and the extraction pump, where the control device receives a signal from said filling probe and is sensitive to a low filling level (b) of the decompression chamber, an intermediate filling level (i) of the decompression chamber and at least one high filling level (h1, h2) of the decompression chamber, and wherein the control device is configured for causing:
stopping, respectively reducing the flow rate, of the extraction pump when content in the decompression chamber reaches the low filling level (b);
running, respectively increasing the flow rate, of the extraction pump when content in the decompression chamber reaches the intermediate filling level (i);
stopping, respectively reducing the flow rate, of the supply pump when content in the decompression chamber reaches a high filling level (h1, h2) of the vat;
characterized in that the equipment comprises a command for switching between:
a first mode of operation, corresponding to the treatment of the berries by decompression, wherein the control device is sensitive to a first high level (h1), and wherein the supply pump is stopped, respectively the flow rate thereof is reduced, when the content of the decompression chamber reaches the first high filling level; and
a second mode of operation, corresponding to the treatment of the juice from the berries by decompression, wherein the control device is sensitive to at least one second high level (h2), above the first high level (h1), and wherein the supply pump is stopped, respectively the flow rate thereof is reduced, when the content of the decompression chamber reaches the second high filling level (h2).

12. The equipment according to claim 11, comprising a plurality of filling probes, where at least one filling probe is respectively associated with the low filling level (b), intermediate filling level (i), first high filling level (h1), and second high filling level (h2).

13. The equipment according to claim 11, comprising a filling probe associated with a high filling level, where the probe has a freedom of movement between a first position corresponding to the first high filling level (h1) and a second position (h2) corresponding to the second high filling level.
